(19) United States
(12) Patent Application Publication
(10) Pub. No.: US 2002/0192472 A1
(43) Pub. Date: Dec. 19, 2002

(54) Easily cleanable coating

(76) Inventors: Bernd Metz, Sertoriusring (DE); Gerhard Weber, Bechenheim (DE); Mevluda Blecker, Mainz (DE)

Correspondence Address: STRIKER, STRIKER & STENBY, 103 East Neck Road, Huntington, NY, 11743, US

(21) Appl. No.: 09/866,419

(22) Filed: May 25, 2001

(51) Int. Cl. C03C 17/42

(52) U.S. Cl. 428/426

(57) ABSTRACT

A process for making a product with a long-lasting easily cleanable surface is described. By said process, there is applied to the surface a mixture comprising a hydrolyzable, network-forming gel and a hydrophobic substance. The gel is preferably formed from SiO₂, Al₂O₃, Fe₂O₃, In₂O₃, SnO₂, ZrO₂, B₂O₃ and/or TiO₂, and the hydrophobic substance is preferably chemically linked with the gel network.

### DESCRIPTION

The invention relates to a process for making a product with an easily cleanable surface by coating the surface with a hydrophobic material and to products obtained by said process.

It is generally known to provide objects with soil-repelling substances. For example, it is known to treat the surface of glasses, glass-ceramics, glazings or even rocks with a silicone to make them soil-repellent and water-repellent. This is usually accomplished by rendering the surface of the objects to be treated hydrophobic by applying a liquid composition. A multitude of chemicals are commonly used for this purpose, but particularly silicone oils and/or fluorinated silanes. The surfaces treated in this manner are difficult to wet, because the water beads up and runs off. Dirt adheres to the treated surfaces only slightly and can therefore be readily removed. This is particularly advantageous for outdoor use, because, for example in the case of skylights and/or glass roofs such as those on winter gardens etc, the deposited dirt is entrained and removed as a result of the rainwater beading up and running off. It is thus possible to keep such surfaces permanently clean without additional cleaning.

The drawback of this method is that the applied chemicals can form permanent bonds only by reacting with OH groups directly available on the substrate material. Because without appropriate pretreatment, for example, with hydrogen/oxygen plasma, sufficiently reactive OH groups are not present on the surface of the objects, particularly on glass, said method gives rise only to a very thin, mostly monomolecular hydrophobic coating which during use, particularly owing to mechanical stress such as, for example, cleaning and/or abrasion by wind and dust, is rubbed off quickly so that the desired self-cleaning property is lost.

Attempts have already been made to improve the durability of such coatings. For example, EP-A-0 658 525 describes the preparation of a water-repellent multilayer film involving the preparation of three different sol solutions which are then mixed and applied to a glass substrate forming a gel coating on the glass surface. Heating then gives rise to a superficial metal oxide layer. To this metal oxide layer is then applied a fluoroalkylsilane coating, as previously described. JP-A-11 092 175 describes a process whereby methoxysilane or an ethoxysilane compound containing a fluorocarbon chain is attached to the surface of small particles with a diameter of 100 nm. The particles modified in this manner are then dissolved in an aqueous medium and applied to the surface to be coated. The solvent is then removed and the residue baked. This affords a surface coated with small hydrophobic particles.

WO 99/64363 describes the preparation of a water-repellent surface which comprises first roughening the surface of the glass and removing all metal ions present on the surface. A water-repellent film is then applied in a known manner to the previously treated surface. The roughening of the surface makes it possible for the water repellant to fill the roughness valleys.

WO 99/02463 describes the preparation of a scratch-resistant coating which involves applying to the surface an organic substance with a silicone-like network. This is followed by a heat treatment for which the temperature and duration are chosen so that the applied purely organic layer is substantially degraded and/or removed, but so that in the topmost molecular layer the inorganic molecules of the support material and the organic molecules of the applied substance can form a compound. In this manner, an organic substance, for example a methyl group, is directly attached to the silicon atom of the glass surface with formation of a Si—C bond.

All hydrophobic and possibly soil-repellent properties conferred by said processes are not sufficiently durable in use and are rapidly lost, particularly as a result of mechanical stress.

The object of the invention is therefore to provide an easy-care article whose easy-care and soil-repellent finish is long-lasting and which is abrasion-resistant even under stress so that the aforesaid easy-care properties of the object or product are retained for a long time.

According to the invention, this objective is reached through the processes defined in the patent claims and through the product thus obtained.

According to the invention, we have now found that a uniform, resistant coating or a coating on a product can be obtained by providing the surface of said product with a layer which comprises a thin metal oxide network or metal oxide matrix, and a hydrophobic substance uniformly distributed therein. This layer is usually a uniform layer of a coherent metal oxide network spread out in sheet-like manner. The metal oxide networks of the invention can have open or closed pores. The metal oxide layers of the invention are formed by heating an applied gel layer and remain on the product as a solid coating.

The gels used according to the invention are, in particular, metal oxide gels prepared by a sol-gel process. The gels are formed in situ during application to the article or product to be coated, giving rise to a uniform, continuous gel network on the surface of the object to be coated. Preferred metal oxides are SiO₂, Al₂O₃, Fe₂O₃, SnO₂, ZrO₂, B₂O₄ [sic-Translator] and/or TiO₂. Preferred gels are the hydrogels, alkogels, xerogels and/or aerogels. The addition, according to the invention, of the hydrophobic and optionally also oleophobic substance to the sol mixture before or during gel formation ensures that the hydrophobic substance will be uniformly distributed in the entire volume of the forming gel network and that it will be chemically bound by polycondensation, for example to the silanol group thereof. In this manner, it is possible to confer to the surface thus treated pronounced abrasion-resistant and durable soil-repellent properties.

The general preparation of gel coatings by means of a sol-gel process is in itself known and has been frequently described. By this process, in a solution, preferably an aqueous and/or alcoholic solution, a polymer reaction is usually made to occur with inorganic metal salts or organometallic compounds such as metal alkoxides by hydrolysis, giving rise to a colloidal suspension, namely a sol. By further hydro-lysis, a coherent gel network is formed from the sol. Preferably, the gel is formed directly during the coating. The final formation of the entire gel network is preferably accelerated by heating. Typical temperatures therefor are between 0° C. and 200° C., preferably between 20° C. and 200° C. and particularly between room temperature and 170° C., a temperature of 150° C. being especially preferred. By appropriate selection of the hydrolysis conditions, it is possible to produce very dense, namely more or less pore-free gel networks or networks presenting only the tiniest pores. Preferred metal alkoxides are metal C₁-C₄ alkoxides, among which metal methoxides and metal ethoxides are particularly preferred. Among the metal salts, the metal nitrates are preferred. The hydrolysis with sol formation is usually started with excess distilled water. To complete the sol formation, the mixture is then allowed to stand at ambient temperature or optionally at elevated temperature for an extended period, for example for two to four days.

Suitable as hydrophobic substances are generally those hydrophobic substances that can be incorporated into the forming gel. For the process of the invention, it is preferred to use hydrophobic substances capable of distributing themselves very uniformly in the gel-forming sol solution. The hydrophobic substances used in the process of the invention are thus preferably in themselves slightly water-soluble or can be rendered water-soluble with the aid of solubilizers or by hydrolysis. Examples of such substances are natural and synthetic oils and/or long-chain fatty acids, preferably fatty acids with a chain of at least six carbon atoms and particularly at least ten carbon atoms. Particularly preferred, however, are hydrophobic oleophobic substances and, in particular, silicones and silanes, siloxanes, silicone oils and silicone greases. The silicone compounds used according to the invention can be linear or branched or possibly also contain cyclic silane groups. Methylphenyl silicone is an example of a particularly well suited silicone according to the invention.

The hydrophobic substances used according to the invention preferably contain fluorine and, in particular, at least 5% and preferably at least 10% of fluorine atoms (based on the total number of atoms of the hydrophobic substance finally incorporated after sintering). Preferably, however, they contain at least 20% of fluorine atoms, 30% being particularly preferred. Although it has been found that the incorporation of the hydrophobic substances according to the invention by the in-situ process results in lasting soil repellency, it is preferred to link said hydrophobic substances chemically with the gel network with the aid of reactive groups and particularly with the aid of reactive silanol groups. Hydrophobic substances with methoxy, ethoxy, propoxy, butoxy or isocyanate groups and chlorosilanes are particularly well suited.

The silanes preferred according to the invention have the general formula

(CFₓH_{y})—(CFₐH_{b})ₙ—(CF_{a′}H_{b′})ₘ—Si—(OR)₃

wherein x and y independently of each other stand for 0, 1, 2 or 3 and x+y=3, and a,a′ and b,b′ independently of each other stand for 0, 1 or 2, and a+b as well as a′+b′=2, and n and m independently of each other denote an integer from 0 to 20 and together add up to a maximum of 30, R being a straight-chain, branched, saturated or unsaturated (optionally heteroatom-containing) C₁-C₈-alkyl group. Preferred alkyl groups are methyl, ethyl and propyl groups.

In a preferred embodiment, x=3 and y=0 so that in the foregoing general formula CF₃ is an end group. In another preferred embodiment of the invention, a=2 and a′=0 so that CF₂ and CH₂ blocks are formed. Naturally, more than two blocks can be present in the chain, and the CF₂ and CH₂ blocks can be interchanged. It is, of course, preferred to have the fluorinated blocks ending at the Si atom. Preferred values of n are 1-10, preferably 1-8, and for m they are 0-10 and preferably 0-8. In the gel solution to be applied, the weight ratio of the hydrophobic substance to the gel network is preferably from 0.01:1 to 1:1, a ratio between 0.05:1 and 0.2:1 being preferred.

The mixture of gel and hydrophobic substance according to the invention is applied by conventional coating methods, with spraying and dip-coating being preferred. The film thickness can be controlled by adjusting the viscosity of the coating mixture and the rate at which the object to be coated is withdrawn from the dipping solution. According to a particular embodiment, therefore, the coating mixture also contains a viscosity modifier such as PVP, PVA and PEO¹. According to the invention, the preferred film thickness is between 0.5 nm and 1 μm, a film thickness of <200 nm being preferred. After application, the film is dried at room temperature, preferably for at least 1 minute and particularly for at least 3 minutes, dried and then made to harden at an elevated temperature at which optionally added substances such as viscosity modifiers are pyrolyzed or burned. The drying time depends on the film thickness produced, the actual temperature and the vapor pressure of the solvent and is at least 1 minute and particularly at least 3 minutes. The drying time is usually 4-6 minutes. The sintering or hardening of the applied film preferably occurs at a temperature of 150-400° C. and preferably at 250-380° C. The hardening time is usually at the most 1 hour, a maximum of 45 min and particularly a maximum of 30 min being preferred. PVp=polyvinylpyrrolidone, PVA=polyvinyl acetate, PEO=polyethylene oxide-Translator

By means of the degree of hydrolysis, the viscosity of the coating solution, particularly of the dipping solution, can be adjusted accurately to a value appropriate for the withdrawal of the object being coated. In this manner, for a known viscosity and for a known withdrawing rate, the film thickness can be produced in exactly reproducible manner. A change in viscosity when using the coating or dipping solution can be adjusted to the desired value in simple manner by dilution with a solvent, for example ethanol, or by adding additional hydrolyzable sol-gel solution.

By the process of the invention, it is also possible to adapt the refractive index of the coating to the support material. This can be accomplished, for example, by mixing different metal oxides. The refractive index of SiO₂ is n=1.45 and that of TiO₂ is n=2.3. In the SiO₂/TiO₂ system, any refractive index within these limits can be obtained, depending on the composition. By adjusting the refractive index and the film thickness, the process of the invention is also particularly suitable for preparing interference layers, for example to reduce reflectivity.

In a particular embodiment of the invention, the durable hydrophobic film is provided, by means of appropriate measures taken before, during or after the heat-hardening, with a surface microstructure whereby the hydrophobic properties of the film are enhanced and the cleaning of the film is facilitated, or the film is provided with an antireflection effect or this effect is enhanced. Such effects can be achieved by incorporating particles or by embossing. In this manner, it is possible to obtain surface microstructures with, for example, knobs which limit contact between dirt particles and the surface coated according to the invention to only a few contact points as, for example, in the “lotus effect”. In this manner, the desired cleaning effect is further enhanced.

In principle, it is possible to coat by the process of the invention any materials capable of withstanding the afore-described sintering temperature. These include, in particular, metals, plastics, inorganic minerals, rocks, such as marble and granite, and burned clays. It is particularly preferred, however, to coat glass and glass-ceramics by the process of the invention. Preferred glasses for this purpose are borosilicate, soda-lime and optical glasses. The process of the invention is particularly well suited for producing easily cleanable flat glasses and particularly float glasses, curved glasses, optical lenses, glass tubes, TV and PC screens and front glasses therefor, furthermore glass-ceramic products, motor vehicle glass enclosures, enameled and/or ceramic products. Preferred flat glasses are, for example window glasses, mirror glasses, shower enclosure glasses, glass shelves, cover glasses for solar collectors, sight glasses, instrument glasses, glass keyboards, touch screen panels, display cover glasses, for example for mobile telephones and laptops, glasses for furnaces, for example baking oven panels, glass baking trays and/or glass baking containers, lamp cover glasses and glasses for refrigerators and furniture. Curved glasses are, for example, spotlight glasses, lamp cover glasses, watch glasses and/or sanitary glasses. Glass lenses are, for example, spectacle lenses and ocular and objective glasses in optical devices. Glass tubes are, for example, solar collector tubes and wastewater pipes. Vehicle glass enclosures are, for example, windows and instrument covering glasses for automotive vehicles, for vehicles that move on tracks, for example trains etc, for ships and for airplanes. Enameled products are, for example, baking trays and sauce pans, and sanitary objects are wash basins, urinals, bathtubs and toilet bowls. Ceramic products are, for example, floor tiles, roofing tiles and the aforesaid sanitary objects.

The process of the invention is also suited for coating household objects, such as drinking glasses, glass cooking utensils, and cooking areas made of glass-ceramics obtainable, for example, under the CERAN tradename. The process of the invention is also suitable for coating enameled cooking utensils, for example pots and pans.

By the process of the invention, however, it is also possible to produce multiple optical interference layers, for example reflectivity-reducing layers. Such reflectivity-reducing layers according to the invention are preferably produced as the outermost layer facing the surroundings or air.

The invention will now be illustrated in greater detail by way of the following examples.

### EXAMPLE 1

### Preparation of a Hydrophobically Modified SiO₂ Dipping Solution

88.6 mL of methyl silicate, 80 mL of distilled water and 10 mL of glacial acetic acid were stirred into 240 mL of ethanol. The resulting solution was allowed to stand 72 hours. It was then diluted with 1580 mL of ethanol, and the hydrolysis was stopped with 2 mL of 37% hydrochloric acid solution. Then, 8.6 mL of tridecafluorooctyltriethoxysilane (supplied under the tradename Dynasylan F 8261 by DEGUSSA-HÜLS, Frankfurt, Germany) was added with stirring.

The coating was applied according to the invention in a single dipping step and allowed to dry for 5 min at room temperature. It was then baked at 250° C. for a maximum of 30 min, which caused the silica gel to harden.

### EXAMPLE 2

### Preparation and Testing of a Coating of the Invention

A clean 2-mm-thick 10×20 cm panel of borosilicate glass was immersed at room temperature in the SiO₂ dipping solution described hereinabove in Example 1 and was then withdrawn from the solution at a rate of 20 cm/minute. The coating film thus applied was allowed to dry for 5 min at room temperature and was then baked for 20 min in an oven at 250° C. (Table 1, coating 1) or at 300° C. (Table 1, coating 2). After the baking, the coating of the invention was about 120 nm thick. The hydrophobing process was evaluated by determining the contact angle with water. This was done with a model G 10 contact angle meter supplied by KRÜSS, Hamburg [Germany]. By this method, freshly cleaned glass surfaces show a contact angle of ≦20°, coated glass surfaces one of about 60° and surfaces freshly rendered hydrophobic one of ≧100°.

Immediately after the preparation according to the invention, a value of 110° was measured at room temperature in this manner. Thereafter, a Schrubb test was performed as follows. A piece of felt having an contact surface of about 3 cm² and moistened with water was moved on the test specimen back and forth while subjecting it to a total load of m=1 kg. Here, a rubbing cycle corresponds to one to and fro movement.

After 500 rubbing cycles by the Schrubb test, the contact angle was still 102°, after 1000 cycles it was 103° and after 2000 cycles it was still 100°, within an accuracy of ±3°.

### EXAMPLE 3

### Comparative Example

### Hydrophobing by Use of a Fluoroalkylsilane

A glass surface was rendered hydrophobic in accordance with the prior art by applying tridecafluoro-octyltriethoxysilane (F 8262, supplied by DEGUSSA-HÜLS). The fluoroalkylsilane was applied to the entire surface with a textile cloth and fixed for 20 min at 200° or 250° C. Determination of the contact angle with water showed immediately after preparation a value of 108°. After 500 rubbing cycles by the Schrubb test (see above), the contact angle was 81°, after 1000 cycles it was 68° and after 2000 cycles it was still 67°. Similar values were also obtained for identically tested hydrophobic glass surfaces from different manufacturers.

### EXAMPLE 4

### Comparative Example

### Hydrophobing by Use of a Silicone Oil

By applying hydromethylpolysiloxane (Fluid 1107, supplied by DOW CORNING), a glass surface was rendered hydrophobic in accordance with the prior art. The silicone oil was applied to the entire surface with a textile cloth and fixed at 180° C. for 20 minutes. Determination of the contact angle with water showed immediately after preparation a value of 102°. After 500 rubbing cycles by the Schrubb test (see above), the contact angle was 87°, after 1000 cycles it was 71° and after 2000 cycles it was still 51°. Similar values were also obtained for identically tested hydrophobic glass surfaces from different manufacturers.

### EXAMPLE 5

### Comparative Example

### Performance of Commercially Available Hydrophobic Glass Surfaces

Four different commercially available hydrophobic glasses from different manufacturers were subjected to a rubbing or Schrubb test as described in Example 2. The test results are summarized in Table 1.

TABLE 1
Contact Angle with Water in Degrees on Different Hydrophobic
Glass Surfaces After n Rubbing Cycles

| Preparation/Origin | n = 0 | n = 500 | n = 1000 | n = 2000 |
|---|---|---|---|---|
| Coating 1, according to | 114 | 106 | 102 | 101 |
| invention, Example 2 | | | | |
| (250° C.) | | | | |
| Coating 2, according to | 110 | 102 | 103 | 100 |
| invention, Example 2 | | | | |
| (300° C.) | | | | |
| Example 3 (Comp. Example | 108 | 81 | 68 | 67 |
| according to prior art, | | | | |
| coated with fluoroalkyl- | | | | |
| silane) | | | | |
| Example 4 (Comp. Example | 102 | 87 | 71 | 51 |
| according to prior art, | | | | |
| coated with silicone oil) | | | | |
| Commercially available | 90-99 | 54-89 | 50-71 | — |
| hydrophobic glass sur- | | | | |
| faces as per Example 5 | | | | |

1. Process for making a product with a long-lasting, easily cleanable surface by coating the surface with a hydrophobic material, characterized in that to the surface is applied a mixture comprising a hydrolyzable, network-forming gel and a hydrophobic substance.

2. Process according to claim 1, characterized in that the gel is made to harden after it has been applied.

3. Process according to one of the preceding claims, characterized in that the gel is a hydrogel, alkogel, xerogel and/or aerogel.

4. Process according to one of the preceding claims, characterized in that the gel is formed from SiO₂, Al₂O₃, Fe₂O₃, In₂O₃, SnO₂, ZrO₂, B₂O₃ and/or TiO₂.

5. Process according to one of the preceding claims, characterized in that the hydrophobic substance is chemically linked with the gel network.

6. Process according to one of the preceding claims, characterized in that the hydrophobic substance is a silane.

7. Process according to one of the preceding claims, characterized in that the silane has the general formula
(CFₓH_{y})—(CFₐH_{b})ₙ—(CF_{a′}H_{b′})ₘ—Si—(OR)₃
wherein
x and y independently of each other stand for 0, 1, 2 or 3, and x+y=3,
a, a′ and b, b′ independently of each other stand for 0, 1 or 2 and a+b as well as a′+b′=2,
n and m independently of each other denote a numeral from 0 to 20 and together add up to a maximum of 30, and
R is a straight-chain, branched, saturated or unsaturated C₁-C₈-alkyl group optionally containing heteroatoms.

8. Process according to one of the preceding claims, characterized by preparing an organometallic sol solution hydrolyzable with gel formation, dissolving therein a hydrophobic substance and applying said solution to the surface to be treated.

9. Process according to claim 8, characterized in that the solution is applied by dipping, spraying, spinning, rolling, curtain-coating or screen-printing.

10. Product with an easily cleanable surface, obtained by one of claims 1 to 9.

11. Product according to claim 10, characterized in that it is a window glass, mirror glass, shower enclosure glass, glass shelf, cover glass for solar collectors, sight glass, instrument glass, glass keyboard, touch screen panel, display cover glass, glass for furnaces, lamp cover glass, glass for refrigerators or furniture, spotlight glass, lamp cover glass [sic-Translator], watch glass, sanitary glass, glass for eyeglass lenses, ocular or objective glass in optical devices, a solar collector tube, a wastewater pipe, a TV screen or PC monitor glass, a TV or PC front cover glass, a window, an instrument-covering glass for motor vehicles, trains, ships or airplanes, a baking tray, a sauce pan, a sanitary object, a floor tile or a roofing tile.
